(19) United States
(12) Patent Application Publication
(10) Pub. No.: US 2025/0005221 A1
(43) Pub. Date: Jan. 2, 2025

(54) SYSTEM AND METHOD FOR PERFORMING HOLE PROFILE MODELING IN A VIRTUAL FABRICATION ENVIRONMENT

(71) Applicant: Coventor, Inc., Cary, NC (US)

(72) Inventors: Qing Peng Wang, Shanghai (CN); Cheng Li, Fremont, CA (US); Yu De Chen, Tainan City (TW); Shi-hao Huang, Kaohsiung City (TW); Benjamin Vincent, Fremont, CA (US); Joseph Ervin, San Jose, CA (US)

(21) Appl. No.: 18/710,421

(22) PCT Filed: Nov. 7, 2022
(86) PCT No.: PCT/US2022/049088

§ 371 Date: May 15, 2024

Related U.S. Application Data
(60) Provisional application No. 63/280,592, filed on Nov. 17, 2021.

(51) Int. Cl. G06F 30/17

(52) U.S. Cl. CPC G06F 30/17

(57) ABSTRACT

Systems and methods for performing hole profile modeling in a semiconductor device virtual fabrication environment are discussed. More particularly, hole profiling modeling may be performed for complicated holes used in fabricating semiconductor devices to support DOEs to optimize the fabrication process.

### BACKGROUND

This application claims the benefit of, and priority to, U.S. Provisional Patent Application No. 63/280,592, filed Nov. 17, 2021, entitled “System and Method for Performing Hole Profile Modeling in a Virtual Fabrication Environment”, the contents of which are incorporated herein in their entirety.

### RELATED APPLICATION

Semiconductor development organizations at integrated device manufacturers (IDMs) and independent foundries spend significant resources developing the integrated sequence of process operations used to fabricate the chips (integrated circuits (ICs)) they sell from wafers (“wafers” are thin slices of semiconductor material, frequently, but not always, composed of silicon crystal). A large portion of the resources is spent on fabricating experimental wafers and associated measurement, metrology (“metrology” refers to specialized types of measurements conducted in the semiconductor industry) and characterization structures, all for the purpose of ensuring that the integrated process produces the desired semiconductor device structures. These experimental wafers are used in a trial-and-error scheme to develop individual processes for the fabrication of a device structure and also to develop the total, integrated process flow. Due to the increasing complexity of advanced technology node process flows, a large portion of the experimental fabrication runs result in negative or null characterization results. These experimental runs are long in duration, weeks to months in the “fab” (fabrication environment), and expensive. Recent semiconductor technology advances have dramatically increased the complexity of integrated semiconductor fabrication processes. The cost and duration of technology development using this trial-and-error experimental methodology has concurrently increased.

A virtual fabrication environment for semiconductor device structures offers a platform for performing semiconductor process development at a lower cost and higher speed than is possible with conventional trial-and-error physical experimentation. In contrast to conventional CAD and TCAD environments, a virtual fabrication environment is capable of virtually modeling an integrated process flow and predicting the complete 3D structures of all devices and circuits that comprise a full technology suite. Virtual fabrication can be described in its most simple form as combining a description of an integrated process sequence with a subject design, in the form of 2D design data (masks or layout), and producing a 3D structural model that is predictive of the result expected from a real/physical fabrication run. A 3D structural model includes the geometrically accurate 3D shapes of multiple layers of materials, implants, diffusions, etc. that comprise a chip or a portion of a chip. Virtual fabrication is done in a way that is primarily geometric, however the geometry involved is instructed by the physics of the fabrication processes. By performing the modeling at the structural level of abstraction (rather than physics-based simulations), construction of the structural models can be dramatically accelerated, enabling full technology modeling, at a circuit-level area scale. The use of a virtual fabrication environment thus provides fast verification of process assumptions and visualization of the complex interrelationship between the integrated process sequence and the 2D design data.

### BRIEF SUMMARY

Embodiments of the present invention provide the ability to perform hole profile modeling in a virtual fabrication environment. More particularly, embodiments enable the virtual fabrication environment to model complicated holes such as channel holes and vias in semiconductor device structures. For example, embodiments enable the modeling of channel hole profiles in advanced 3DNAND/DRAM structures to support virtual Design of Experiments (DOE).

In one embodiment, a computing device-implemented method for performing hole profile modeling in a virtual fabrication environment includes receiving a process sequence and design data for a semiconductor device structure to be virtually fabricated. The method further includes receiving a user-specified hole profile modeling step for the process sequence. The method additionally includes performing a virtual fabrication run using the process sequence and design data that builds a 3D structural model predictive of a result of a physical fabrication of the semiconductor device structure with the execution of the hole profile modeling step generating a hole profile for one or more holes in the 3D structural model. The method also outputs result data generated from the hole profile modeling step.

In another embodiment, a system for performing hole profile modeling includes at least one computing device equipped with one or more processors that is configured to generate a virtual fabrication environment that includes a hole profile modeling module. The hole profile modeling module when executing receives a process sequence and design data for a semiconductor device structure to be virtually fabricated and receives a user-specified hole profile modeling step for the process sequence. The hole profiling module further performs a virtual fabrication run using the process sequence and design data that builds a 3D structural model predictive of a result of a physical fabrication of the semiconductor device structure. The execution of the hole profile modeling step generates a hole profile for one or more holes in the 3D structural model. The system further includes a display in communication with the at least one computing device, the display configured to display result data from the hole profile modeling step.

### BRIEF DESCRIPTION OF THE DRAWINGS

The accompanying drawings, which are incorporated in and constitute a part of this specification, illustrate one or more embodiments of the invention and, together with the description, help to explain the invention. In the drawings:

FIG. 1 depicts an exemplary virtual fabrication environment suitable for practicing an embodiment of the present invention;

FIG. 2 depicts an exemplary 3D viewer provided by the virtual fabrication environment;

FIG. 3 depicts an exemplary memory array with defects;

FIG. 4 depicts an exemplary overview of a hole sweep process performed by embodiments to model hole profiles;

FIG. 5 depicts an exemplary sequence performed by an embodiment to perform a hole sweep;

FIG. 6 depicts an exemplary user interface for receiving user-supplied input parameters that are used for the hole profile modeling step in an embodiment;

FIGS. 7A-7H graphically depict input parameters used for the hole profile modeling step in an embodiment;

FIG. 8 depicts an exemplary hole profile in an embodiment;

FIG. 9 shows auto matching of an incoming photoresist pattern location for a structure with two holes in the same layer in an exemplary embodiment;

FIG. 10 depicts results of a DOE performed for a two stack channel hole and

FIG. 11 depicts a sequence of steps performed in the virtual fabrication environment to perform hole profile modeling in an exemplary embodiment.

### DETAILED DESCRIPTION

With recent advances in semiconductor fabrication, holes and openings in the semiconductor devices being fabricated, such as, but not limited to, channel holes and vias used in 3DNAND/DRAM and other types of semiconductor devices have become greater in number as well as increasingly longer and narrower as fabrication processes have evolved. Additionally, the holes are sometimes fabricated from two stacks which presents additional alignment issues. As a result, modeling these holes has presented an increasingly difficult challenge. Embodiments of the present invention provide a virtual fabrication environment that enables hole profile modeling of complicated holes used in the fabrication of semiconductor devices such as, but not limited to, channel holes in 3DNAND/DRAM structures. However, prior to discussing the hole profile modeling provided by embodiments in greater detail, an exemplary 3D virtual fabrication environment which may be utilized to practice the embodiments is first described.

### Exemplary Virtual Fabrication Environment

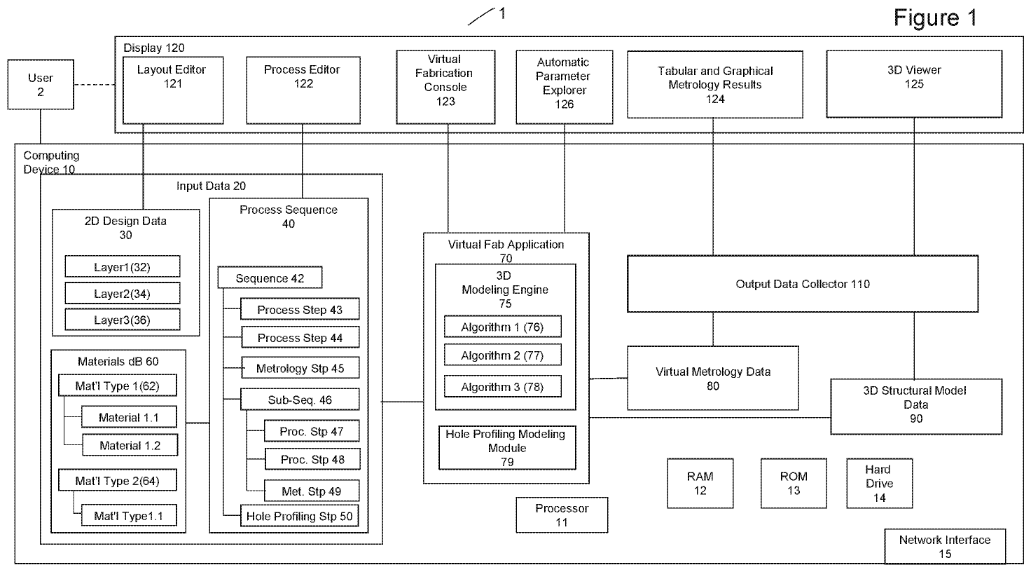

FIG. 1 depicts an exemplary virtual fabrication environment 1 suitable for practicing an embodiment of the present invention. Virtual fabrication environment 1 includes a computing device 10 accessed by a user 2. Computing device 10 is in communication with a display 120. Display 120 may be a display screen that is part of computing device 10 or may be a separate display device or display surface in communication with computing device 10. Computing device 10 may be a PC, laptop computer, tablet computing device, server, mobile computing device or some other type of computing device equipped with a processor 11 and able to support the operations of 3D modeling engine 75 (described further below). The processor may have one or more cores. The computing device 10 may also include volatile and non-volatile storage such as, but not limited to, Random Access Memory (RAM) 12, Read Only Memory (ROM) 13 and hard drive 14. Computing device 10 may also be equipped with a network interface 15 so as to enable communication with other computing devices.

Computing device 10 may store and execute virtual fabrication application 70 including 3D modeling engine 75. 3D modeling engine 75 may include one or more algorithms such as algorithm 1 (76), algorithm 2 (77), and algorithm 3 (78) used in virtually fabricating semiconductor device structures. Virtual fabrication application 70 may also include hole profile modeling module 79 containing executable instructions for hole profile modeling operations. 3D modeling engine 75 may accept input data 20 in order to perform virtual fabrication “runs” that produce semiconductor device structural model data 90. Virtual fabrication application 70 and 3D modeling engine 75 may generate a number of user interfaces and views used to create and display the results of virtual fabrication runs. For example, virtual fabrication application 70 and 3D modeling engine 75 may display layout editor 121, process editor 122 and virtual fabrication console 123 used to create virtual fabrication runs. Virtual fabrication application 70 and 3D modeling engine 75 may also display a tabular and graphical metrology results view 124 and 3D view 125 for respectively displaying results of virtual fabrication runs and 3D structural models generated by the 3D modeling engine 75 during virtual fabrication of semiconductor device structures.

Input data 20 includes both 2D design data 30 and process sequence 40. Process sequence 40 may be composed of multiple process steps 43, 44, 47, 48 and 49. Process sequence 40 may also include one or more virtual metrology measurement process steps 45. Process sequence 40 may further include one or more subsequences which include one or more of the process steps or virtual metrology measurement process steps. 2D design data 30 includes of one or more layers such as layer 1 (32), layer 2 (34) and layer 3 (36), typically provided in an industry-standard layout format such as GDS II (Graphical Design System version 2) or OASIS (Open Artwork System Interchange Standard).

Input data 20 may also include a materials database 60 including records of material types such as material type 1 (62) and material type 2 (64) and specific materials for each material type. Many of the process steps in a process sequence may refer to one or more materials in the materials database. Each material has a name and some attributes such as a rendering color. The materials database may be stored in a separate data structure. The materials database may have hierarchy, where materials may be grouped by types and sub-types. Individual steps in the process sequence may refer to an individual material or a parent material type. The hierarchy in the materials database enables a process sequence referencing the materials database to be modified more easily. For example, in virtual fabrication of a semiconductor device structure, multiple types of oxide material may be added to the structural model during the course of a process sequence. After a particular oxide is added, subsequent steps may alter that material. If there is no hierarchy in the materials database and a step that adds a new type of oxide material is inserted in an existing process sequence, all subsequent steps that may affect oxide materials must also be modified to include the new type of oxide material. With a materials database that supports hierarchy, steps that operate on a certain class of materials such as oxides may refer only to the parent type rather than a list of materials of the same type. Then, if a step that adds a new type of oxide material is inserted in a process sequence, there is no need to modify subsequent steps that refer only to the oxide parent type. Thus hierarchical materials make the process sequence more resilient to modifications. A further benefit of hierarchical materials is that stock process steps and sequences that refer only to parent material types can be created and re-used.

3D Modeling Engine 75 uses input data 20 to perform the sequence of operations/steps specified by process sequence 40. As explained further below, process sequence 40 may include one or more virtual metrology steps 45, 49 that indicate a point in the process sequence during a virtual fabrication run at which a measurement of a structural component should be taken. The measurement may be taken using a locator shape previously added to a layer in the 2D design data 30. In an alternative approach, the measurement location may be specified by alternate means such as (x, y) coordinates in the 2D design data or some other means of specifying a location in the 2D design data 30 instead of through the use of a locator shape. Process sequence may also include one or more hole profile modeling steps 50 that indicate a point in the process sequence during a virtual fabrication run at which a hole profile modeling operation should be performed as described further herein. The performance of the process sequence 40 during a virtual fabrication run generates virtual metrology data 80 and 3D structural model data 90. 3D structural model data 90 may be used to generate a 3D view of the structural model of the semiconductor device structure which may be displayed in the 3D viewer 125. Virtual metrology data 80 may be processed and presented to a user 2 in the tabular and graphical metrology results view 124.

The virtual fabrication environment may include a virtual fabrication console used to set up a virtual fabrication run. The virtual fabrication console 123 allows the user to specify a process sequence and the layout (2D design data) for the semiconductor device structure that is being virtually fabricated. It should be appreciated however that the virtual fabrication console can also be a text-based scripting console that provides the user with a means of entering scripting commands that specify the required input and initiate building of a structural model, or building a set of structural models corresponding to a range of parameter values for specific steps in the process sequence. The latter case is considered a virtual experiment (discussed further below).

The virtual fabrication environment may also include a layout editor. The layout editor 121 displays the 2D design layout specified by the user in the virtual fabrication console 123. In the layout editor, color may be used to depict different layers in the design data. The areas enclosed by shapes or polygons on each layer represent regions where a photoresist coating on a wafer may be either exposed to light or protected from light during a photolithography step in the integrated process flow. The shapes on one or more layers may be combined (booleaned) to form a mask that is used in a photolithography step. The layout editor 121 provides a means of inserting, deleting and modifying a polygon on any layer, and of inserting, deleting or modifying layers within the 2D design data. A layer can be inserted for the sole purpose of containing shapes or polygons that indicate the locations of virtual metrology measurements. For example, rectangular shapes may be added to an inserted layer (indicated by a different color) to mark the locations of virtual metrology measurements. As noted above, other approaches to specifying the locations for the virtual metrology measurements besides the use of locator shapes may also be used. The design data is used in combination with the process data and materials database to build a 3D structural model.

Inserted layers in the design data displayed in the layout editor 121 may include inserted locator shapes. For example, a locator shape may be a rectangle, the longer sides of which indicate the direction of the measurement in the 3D structural model. For example, a first locator shape may mark a double patterning mandrel for a virtual metrology measurement, a second locator shape may mark a gate stack for a virtual metrology measurement and a third locator shape may mark a transistor source or drain contact for a virtual metrology measurement.

As noted, the virtual fabrication environment may also include process editor 122. The user may define a process sequence in the process editor. The process sequence is an ordered list of process steps conducted in order to virtually fabricate the user's selected structure. The process editor may be a text editor, such that each line or group of lines corresponds to a process step, or a specialized graphical user interface. The process sequence may be hierarchical, meaning process steps may be grouped into sub-sequences and sub-sequences of sub-sequences, etc. Generally, each step in the process sequence corresponds to an actual step in the fab. For instance, a sub-sequence for a reactive ion etch operation might include the steps of spinning on photo resist, patterning the resist, and performing the etch operation. The user specifies parameters for each step or sub-step that are appropriate to the operation type. Some of the parameters are references to materials in the materials database and layers in the 2D design data. For example, the parameters for a deposit operation primitive are the material being deposited, the nominal thickness of the deposit and the anisotropy or ratio of growth in the lateral direction versus the vertical direction. This deposit operation primitive can be used to model processes such as chemical vapor deposition (CVD). Similarly, the parameters for an etch operation primitive are a mask name (from the design data), a list of materials affected by the operation, and the anisotropy.

There may be hundreds of steps in the process sequence and the process sequence may include sub-sequences. For example, a process sequence may include a subsequence made up of multiple process steps. The process steps may be selected from a library of available process steps. For a selected step, the process editor may enable a user to specify all required parameters. For example, a user may be able to select a material from a list of materials in the material database and specify a process parameter for the material's use in the process step.

One or more steps in the process sequence may be virtual metrology steps inserted by a user. For example, the insertion of step “Measure CD” (414), where CD denotes a critical dimension, in the process sequence would cause a virtual metrology measurement to be taken at that point in the virtual fabrication run using one or more locator shapes that had been previously inserted on one or more layers in the 2D design data. By inserting the virtual metrology steps directly in the fabrication sequence, virtual metrology measurements may be taken at critical points of interest during the fabrication process. As the many steps in the virtual fabrication interact in the creation of the final structure, the ability to determine geometric properties of a structure, such as cross-section dimensions and surface area, at different points in the integrated process flow is of great interest to the process developer and structure designer.

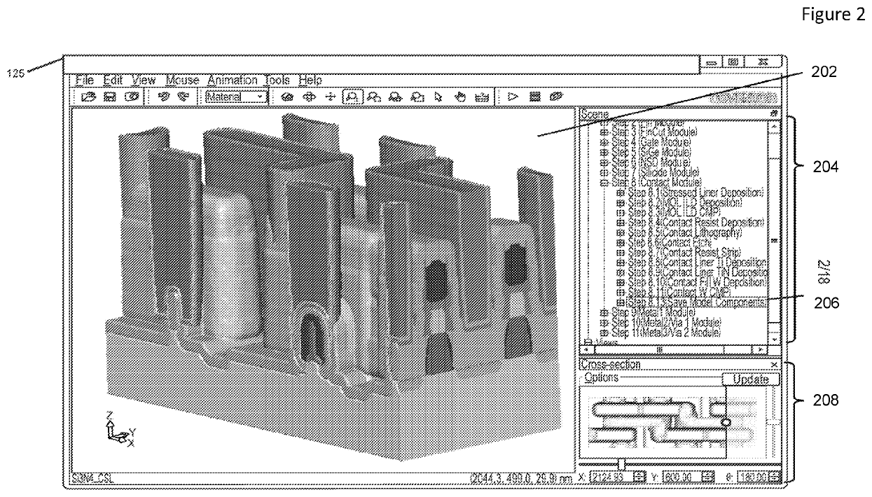

FIG. 2 depicts an exemplary 3D viewer 125 provided by the virtual fabrication environment. The 3D viewer 125 may include a 3D view canvas 202 for displaying 3D models generated by the 3D modeling engine 75. The 3D viewer 125 may display saved states 204 in the process sequence and allow a particular state to be selected 206 and appear in the 3D view canvas. 3D Viewer 125 may provide functionality such as zoom in/out, rotation, translation, cross section, etc. Optionally, the user may activate a cross section view in the 3D view canvas 202 and manipulate the location of the cross section using a miniature top view 208.

While building a single structural model can be valuable, there is increased value in virtual fabrication that builds a large number of models. The virtual fabrication environment enables a user to create and run a virtual experiment/Design of Experiment (DOE). In a virtual experiment, a range of values of process parameters can be explored. A virtual experiment may be set up by specifying a set of parameter values to be applied to individual processes (rather than a single value per parameter) in the full process sequence. A single process sequence or multiple process sequences can be specified this way. The 3D modeling engine 75, executing in virtual experiment mode, then builds multiple models spanning the process parameter set, all the while utilizing the virtual metrology measurement operations described above to extract metrology measurement data for each variation. This capability may be used to mimic two fundamental types of experiments that are typically performed in the physical fab environment. Firstly, fabrication processes vary naturally in a stochastic (non-deterministic) fashion. The virtual fabrication environment described herein, uses a fundamentally deterministic approach for each virtual fabrication run that nevertheless can predict non-deterministic results by conducting multiple runs. The virtual experiment mode allows the virtual fabrication environment to model through the entire statistical range of variation for each process parameter, and the combination of variations in many/all process parameters. Secondly, experiments run in the physical fab may specify a set of parameters to be intentionally varied when fabricating different wafers. The virtual experiment mode of the present invention enables the virtual fabrication environment to mimic this type of experiment as well, by performing multiple virtual fabrication runs on the specific variations of a parameter set.

Each process in the fabrication sequence has its own inherent variation. To understand the effect of all the aggregated process variations in a complex flow is quite difficult, especially when factoring in the statistical probabilities of the combinations of variations. Once a virtual experiment is created, the process sequence is essentially described by the combination of numerical process parameters included in the process description. Each of these parameters can be characterized by its total variation (in terms of standard deviation or sigma values), and therefore by multiple points on a Gaussian distribution or other appropriate probability distribution. If the virtual experiment is designed and executed to examine all of the combinations of the process variations (multiple points on each Gaussian, for example the ±3 sigma, ±2 sigma, ±1 sigma, and nominal values of each parameter), then the resulting graphical and numerical outputs from virtual metrology steps in the sequence cover the total variation space of the technology. Even though each case in this experimental study is modeled deterministically by the virtual fabrication system, the aggregation of the virtual metrology results contains a statistical distribution. Simple statistical analysis, such as Root Sum Squares (RSS) calculation of the statistically uncorrelated parameters, can be used to attribute a total variation metric to each case of the experiment. Then, all of the virtual metrology output, both numerical and graphical, can be analyzed relative to the total variation metric.

In typical trial-and-error experimental practice in a physical fab, a structural measurement resulting from the nominal process is targeted, and process variations are accounted for by specifying an overly large (conservative) margin for the total variation in the structural measurement (total structural margin) which must be anticipated in subsequent processes. In contrast, a virtual experiment can be designed to provide quantitative predictions of the total variation envelope for a structural measurement at any point in the integrated process flow. The total variation envelope, rather than the nominal value, of the structural measurement may then become the development target. This approach can ensure acceptable total structural margin throughout the integrated process flow, without sacrificing critical structural design goals. This approach, of targeting total variation may result in a nominal intermediate or final structure that is less optimal (or less aesthetically pleasing) than the nominal structure that would have been produced by targeting the nominal process. However, this sub-optimal nominal process is not critical, since the envelope of total process variation has been accounted for and is more important in determining the robustness and yield of the integrated process flow. This approach is a shift in semiconductor technology development, from an emphasis on the nominal process to an emphasis on the envelope of total process variation.

To set up and perform a virtual experiment generating virtual metrology measurement data for multiple semiconductor device structural models a user may select a process sequence (which may have been previously calibrated to make the results more structurally predictive and identify/create 2D design data. The user may select process parameter variations to analyze and/or design parameter variations to analyze. The user may insert one or more virtual metrology steps in the process sequence and add measurement locator shapes to the 2D design data. The user may set up the virtual experiment with the aid of a specialized user interface, an automatic parameter explorer 126. The automatic parameter explorer may display, and allow the user to vary, the process parameters to be varied and the list of 3D models to be built with their corresponding different parameter values. The parameter ranges for a virtual experiment can be specified in a tabular format. The 3D modeling engine 75 builds the 3D models and exports the virtual metrology measurement data for review. A virtual experiment mode may provide output data handling from all virtual measurement/metrology operations. The output data from the virtual metrology measurements may be parsed and assembled into a useful form.

With this parsing and assembling, subsequent quantitative and statistical analysis can be conducted. A separate output data collector module 110 may be used to collect 3D model data and virtual metrology measurement results from the sequence of virtual fabrication runs that comprise the virtual experiment and present them in graphical and tabular formats. For example, a tabular-formatted display of virtual metrology data generated by a virtual experiment may be generated. In the tabular formatted display, the virtual metrology data collected during the virtual experiment and the list of virtual fabrication runs may be displayed.

Alternatively or in addition an exemplary 2D X-Y graphical plot display of virtual metrology data generated by a virtual experiment may be displayed. For example, the total variation in shallow trench isolation (STI) step height due to varying 3 parameters in preceding steps of the process sequence may be shown with an indicator representing each virtual fabrication run. The variation envelope may also be displayed as may a depicted conclusion. The virtual experiment results can also be displayed in multi-dimensional graphic formats.

Once the results of the virtual experiment have been assembled, the user can review 3D models that have been generated in 3D viewer 125 and review the virtual metrology measurement data and metrics presented for each virtual fabrication run. Depending on the purpose of the virtual experiment, the user can analyze the output from the 3D modeling engine for purposes of developing a process sequence that achieves a desired nominal structural model, for further calibrating process step input parameters, or for optimizing a process sequence to achieve a desired process window.

The 3D modeling engine's 75 task of constructing multiple structural models for a range of parameter values (comprising a virtual experiment) is very compute intensive and therefore could require a very long time (many days or weeks) if performed on a single computing device. To provide the intended value of virtual fabrication, model building for a virtual experiment must occur many times faster than a physical experiment. Achieving this goal requires exploiting any and all opportunities for parallelism. The 3D modeling engine 75 of the present invention uses multiple cores and/or processors to perform individual modeling steps. In addition, the structural models for different parameter values in a set are completely independent and can therefore be built in parallel using multiple cores, multiple processors, or multiple systems.

3D modeling engine 75 may represent the underlying structural model using a voxel-based implicit geometry representation. Voxels are essentially 3D pixels. Each voxel is a cube of the same size, and may contain one or more materials, or no materials. An implicit geometry representation is one in which the interface between materials in the 3D structural model are defined without an explicit representation of the (x,y,z) coordinate locations of that interface. Many of the operations performed by the 3D modeling engine are voxel modeling operations. Modeling operations based on a digital voxel representation are far more robust than the corresponding operations in a conventional analog solid modeling kernel (e.g. a NURBS-based solid modeling kernel). Such solid modeling kernels generally rely on a large number of heuristic rules to deal with various geometric situations, and modeling operations may fail when the heuristic rules do not properly anticipate a situation. Aspects of semiconductor structural modeling that cause problems for NURBS-based solid modeling kernels include the very thin layers produced by deposition processes and propagation of etch fronts that results in merging faces and/or fragmentation of geometry.

Some simulation tools require a volume mesh to be generated from some form of explicit boundary representation and previous solutions exist for creating a volume mesh of B-rep geometry or from surface meshes. Such volume meshes for finite-element or finite-volume simulation techniques will preserve the location of the interface between materials to a high level of accuracy. Such a volume mesh is called a boundary-conforming mesh or simply a conformal mesh. A key feature of such a mesh is that no element crosses the boundary between materials. In other words, for a volume mesh of tetrahedral elements, then each element is wholly within one material and thus no tetrahedron contains more than one material. However, neither B-rep and similar solid modeling kernels, nor surface mesh representations are optimal for virtual fabrication. Solid modeling kernels generally rely on a large number of heuristic rules to deal with various geometric situations, and modeling operations may fail when the heuristic rules do not properly anticipate a situation. Geometry representations that instead represent the boundaries implicitly do not suffer from these problems. A virtual fabrication system that uses an implicit representation exclusively thus has significant advantages, even if it may not represent the interfaces as accurately.

Geometric data represented with voxels implicitly represents the interface between materials. For example, A B-rep representation may represent the circle as the equation of a circle with radius R with a first material inside the circle and a second material outside. In contrast, a voxel representation of the circle is an array of cubes where each cube stores the material identification numbers within it, and the relative amounts of each material. Since the circle cuts through the voxels along its path, voxels on the boundary of the circle are partially filled with each material. Partially filled voxels indicate that the boundary crosses through that voxel, but does not indicate where and with what orientation. The fill fractions of a boundary voxel and others in its neighborhood may be used to determine the boundary explicitly.

Material properties at a location within the geometry may be approximated using the properties of the majority material within each voxel. For instance, in an operation to determine electrical resistance, if a boundary voxel is more than 50% of a material, then the bulk resistivity of that material is used for all values of x within that voxel, and similarly voxels of 50% or more of a different material use the bulk resistivity of that different material. This is equivalent to filling those voxels full of the majority material. This approach incurs what is called ‘staircasing’ error in the solution over methods that explicitly know the boundary location, and thus know precisely the material at each location, x. One method to compensate for staircasing error is to decrease the size of each voxel when performing the virtual fabrication of the 3D model and thus reduce the volume of boundary voxels. The volume taken up by boundary voxels is much less with the smaller voxel size and thus the error would be less. It should be noted however that decreasing the voxel size greatly increases both the virtual fabrication computation time as well as the simulation time which may lead to unacceptable results in some circumstances.

### Hole Profile Modeling

Embodiments of the present invention enable a virtual fabrication environment to model complicated hole profiles found in advanced semiconductor device structures. The increasing number of holes in today's advanced semiconductor device structures and the high aspect ratios of those holes has made fabricating and performing measurement checks of the holes in the physical fab challenging and indicated a need for the ability to properly model the holes in a virtual fabrication environment in order to efficiently design and fabricate the semiconductor devices. Embodiments provide a hole profile sweep method applied to a 3D structural model of a semiconductor device using user-supplied parameters to model hole profiles. As further described herein, embodiments enable complicated hole profiles to be accurately modeled to support the performance of virtual Design of Experiments (DOE) that enhance the design process and increase fabrication efficiency.

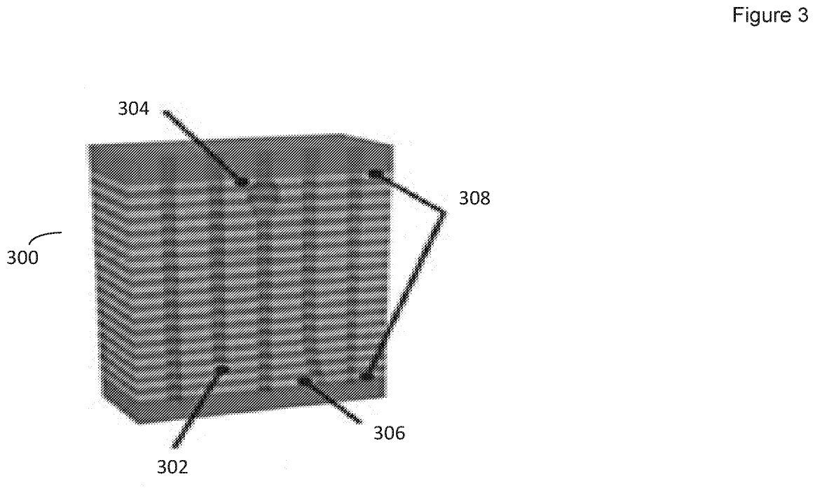

As one non-limiting example of the fabrication challenges presented by today's increasingly complex semiconductor devices, recent advances in the fabrication of 3DNAND memory cells have led to increasing numbers of memory cell layers being used to fabricate the device. To etch a hole through these layers is challenging and can lead to a number of different problems. For example, FIG. 3 depicts an exemplary memory array 300 whose fabrication has led to a number of different defects. One such problem is an incomplete etch 302 where the channel hole does not traverse all the way from the top of the structure to the bottom of the structure. Another common problem is a bowing effect 304 where the channel hole “bows” and expands out of its intended shape in the middle of the structure being fabricated. A further common defect is twisting 306 where the bottom of the channel is offset from the top of the channel instead of being located directly underneath. Further defects include critical dimension (cd) variance 308 between the top cd and bottom cd of the channel hole. These sort of defects can increase in number as the number of layers in the memory array increase. Even an extreme High Aspect Ratio (HAR) memory channel etch (needed by memory channels with an aspect ratio greater than 40) has difficulty at around 90+NAND layers using current plasma etch technologies. To address this issue, fabrication processes that instead use two stacks of memory cells arranged on top of each other instead of one larger stack have been developed (for example two decks of 64 layers provide an equivalent 128 layer array). However, in such an arrangement, an additional difficulty is that the resulting channel holes fabricated from each stack must line up in order for the hole to run the length of the structure. Such a structure has a split hole profile (from the combination of the top stack hole profile and bottom stack hole profile) of the hole traversing the memory layers and the split ‘profile must able to be properly modeled during virtual fabrication.

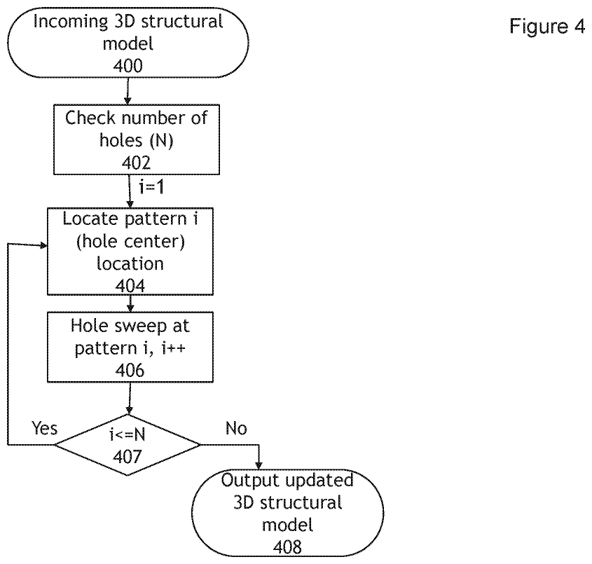

To assist in addressing these fabrication challenges, embodiments provide a technique for conducting a hole “sweep” of the holes in the 3D structural model of semiconductor device that is being virtually fabricated in order to generate accurate hole profiles that support the performance of DOEs. FIG. 4 depicts an exemplary overview of a hole sweep process performed by embodiments to model hole profiles in an embodiment. A 3D structural model 400 of the semiconductor device structure being fabricated is examined to determine the number of holes (N) (step 402) in the structure. To begin, a counter value i representing a (first) current hole location may be set to 1. Then each hole pattern location i is located by examining the structural model data (step 404) and a hole sweep is performed at each hole location as explained further below to generate a hole profile before incrementing the counter (step 406). With each iteration, the counter i is compared to the total number of holes in the structure N (step 407) and if less than or equal to N the process iterates and next hole location is swept (step 404). If all of the holes in the structure have been swept, the revised 3D model structure with the generated hole profile may be output for display or further analysis (408).

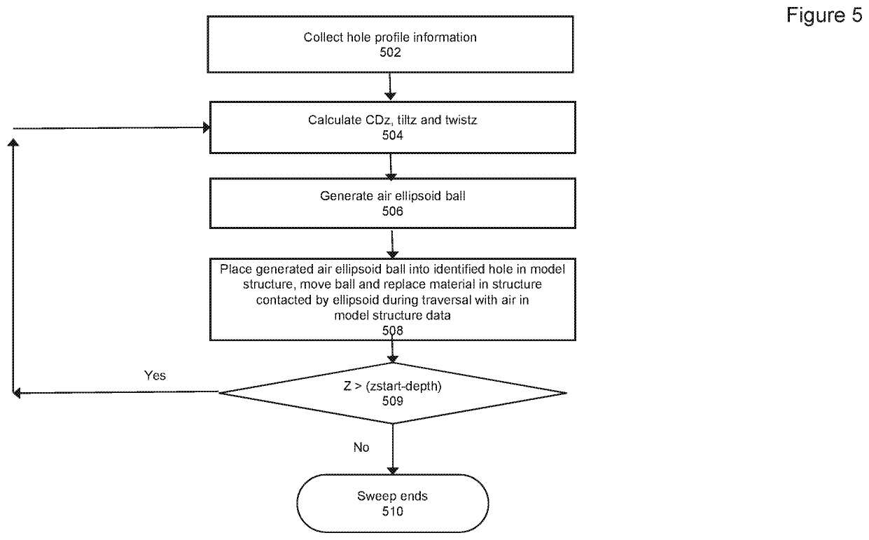

As noted above, for each hole location, embodiments sweep the hole to generate an accurate hole profile. FIG. 5 depicts an exemplary sequence performed by an embodiment to perform a hole sweep in an embodiment. Prior to performing the hole sweep, hole profile information is collected (step 502). In one embodiment, the hole profile information is collected with the aid of a user interface generated in the virtual fabrication environment (discussed further below) that enables a user to enter important parameter information for the hole needed for the hole profile. In another embodiment, the hole profile information may be programmatically retrieved. For example, the hole profile information may include the hole location, the etch depth of the hole, a top CD (hereafter “tcd”), a bow CD (hereafter “bwcd”), a bow location (within the hole), a bottom CD (hereafter “bcd”), a tilt parameter indicating an amount of offset from the top center of the hole to the bottom center of the hole (hereafter “tilt”), a twist parameter indicating a twist angle at the top (hereafter “tcda”), a twist angle at the point of maximum bow CD (hereafter “bwcda”) and/or a twist angle at the bottom (hereafter “bcda”), as well as a starting vertical location in the hole for the sweep (hereafter “startz”) that may frequently be the top vertical location in the hole/channel. The parameters may also include a smoothing parameter controlling a size of a generated air ellipsoid used to perform the sweep (discussed further below) and a speed parameter controlling the speed of the movement of the ellipsoid during the sweep. It should be appreciated that the above parameters are exemplary and embodiments may utilize additional parameters related to the hole profile not specifically disclosed without departing from the scope of the present invention. Similarly, embodiments may utilize only a subset of the parameters discussed above.

Continuing with FIG. 5, for each designated height z in the hole, the hole profile method calculates cdz, tiltz and twistz (step 504) as explained further herein. Using the values, an air ellipsoid ball is generated (step 506) and placed into the 3D structural model at the designated starting location (startz) within the hole. Once placed in the starting location, the air ellipsoid is moved along the hole with the speed parameter controlling the distance of each move. The materials abutting the hole are replaced with air in the model data where the air ellipsoid materials comes into contact with the air ellipsoid during traversal (step 508). A check is performed to see if the current z location after the movement (z=z-speed) is still above the bottom of the hole (z>(startz-depth)) and if so the sequence iterates and cdz, tiltz and twistz are calculated at the new z location (step 504) and the shape and orientation of the air ellipsoid ball are changed accordingly. If the current z location is at the bottom of the hole when checked the sweep ends (step 510).

In one embodiment, the calculation of the critical dimension of z (cdz) is dependent upon whether z is above or below the bow location (bowz). If z is above the bow location, cdz may be calculated as:

$$cdz = tcd + ( Z - startz ) * ( tcd - bowCD ) / ( startZ - bowz ) .$$

If z is below the bow location, cdz may be calculated as:

$$cdz = b o w c d + ( Z - bowZ ) * ( bowcd - bcd ) / ( depth - bowz ) .$$

In one embodiment tiltz may be calculated as:

$$tiltz = 0 + ( Z - zstart ) * ( tilt ) / ( depth )$$

In an embodiment, twistz may be calculated as:

$$twistz = 0 + ( Z - zstart ) * ( twist ) / ( depth )$$

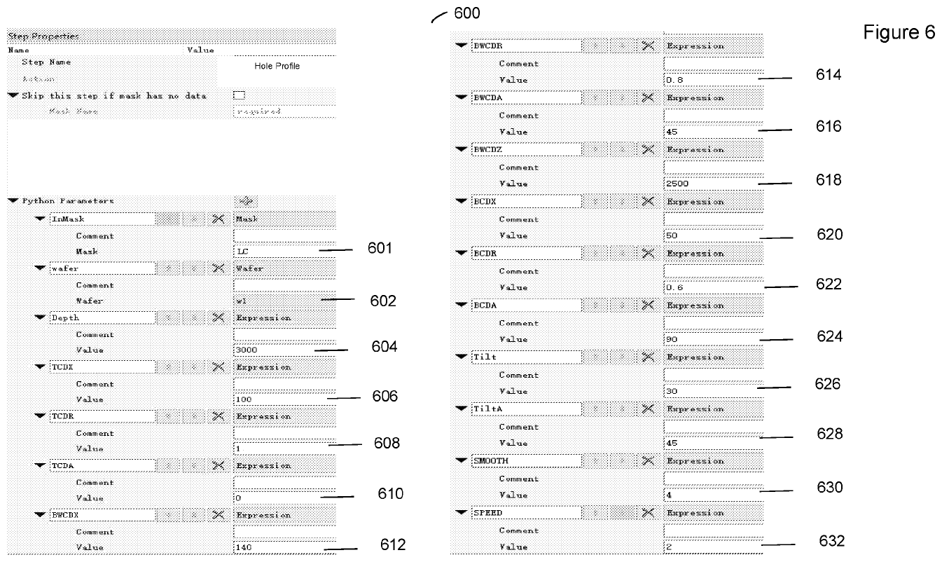

Embodiments may provide a user interface to receive user-supplied parameters for the hole profile modeling step. FIG. 6 depicts an exemplary user interface for receiving user-supplied input parameters that are used for the hole profile modeling step in an embodiment. The exemplary user interface 600 enables a user to specify a mask 601 for pattern recognition, the wafer 602 and the etch depth 604. The user interface also enables the user to specify parameters related to top of the hole/channel such as a top cd 606, a top cd ratio 608 and a top twist angle 610. For example the top cd can be specified in terms of the length of the long axis for the hole at the top (tcdx) 606 and cd ratio may be expressed as the ratio of the short (y) axis of the hole to the long axis of the hole (tcdr) 608. As depicted in FIG. 6, the exemplary tcdr is set to 1 by the user indicating equal values for the short and long axis (i.e. a circular hole with the length of both axis being equal. The exemplary top twist angle (tcda) 610 of the hole angle at the top is set to 0. The user interface 600 also enables the collection of information regarding a bow defect in the hole. For example, input parameters for a maximum bow cd (bwcdx) 612 expressed as a value for the length of the long axis of the hole at the widest part of the bow, the ratio of the short axis to the long axis (bwcdr) 614 at the widest part of the bow, the twist angle at the widest part of the bow (bwcda) 616, and the bow location (bwcdz) 618, expressed as the height z of the maximum bow location in the hole measured from the bottom of the hole, may be collected.

Continuing with the description of FIG. 6, the user interface 600 may also be configured to collect user-supplied input parameters related to the bottom of the hole being profiled. For example, information regarding the bottom cd (bcdx) 620, a bottom cd ratio (bcdr) 622 and bottom twist angle (bcda) 624 may be entered via the user interface 600. For example bcdx 620 can be specified in terms of the length of the long axis for the hole at the bottom of the hole and bcdr 622 may be expressed as the ratio of the short axis of the hole to the long axis of the hole (tcdr). It should be appreciated that the exemplary hole profile specified in FIG. 6 undergoes changes in its profile between the top and the bottom. For example, the long axis of the hole goes from a value of 100 at the top (tcdx) to 140 at the maximum bow location (bwcdx) to 50 at the bottom (bcdx). Similarly, the ratio of the short axis to the long axis of the hole goes from 1.0 (i.e. circular) at the top to 0.8 at the maximum bow location to 0.6 at the bottom indicating the hole changes shape from circular to oval. The angle also changes going from 0 at the top (tcda) to 45 degrees at the bow location (bwcda) to 90 degrees angle at the bottom of the hole (bcda).

User interface 600 may also be used to solicit additional input parameters related to the hole profile. For example, user interface 600 may receive a tilt value 626 indicating a lateral distance between the center of the top hole and the center of the bottom hole, and a global twist value 628 indicating the amount of rotation angle (counter-clock wise) of the channel hole between the bottom and top of the hole. Further, the user interface may receive an input parameter for the ellipsoid height(z) size factor (smooth) 630 and a value indicating the distance between balls for the sweep operation (speed) 632.

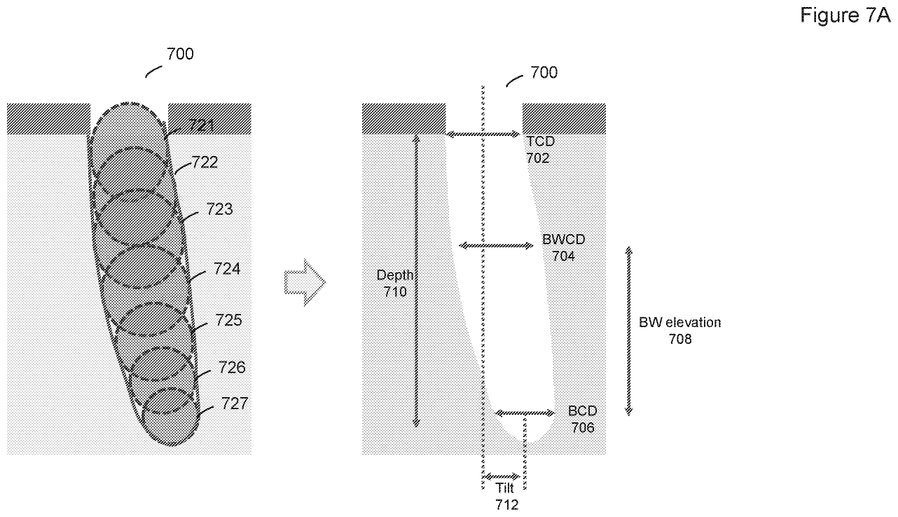

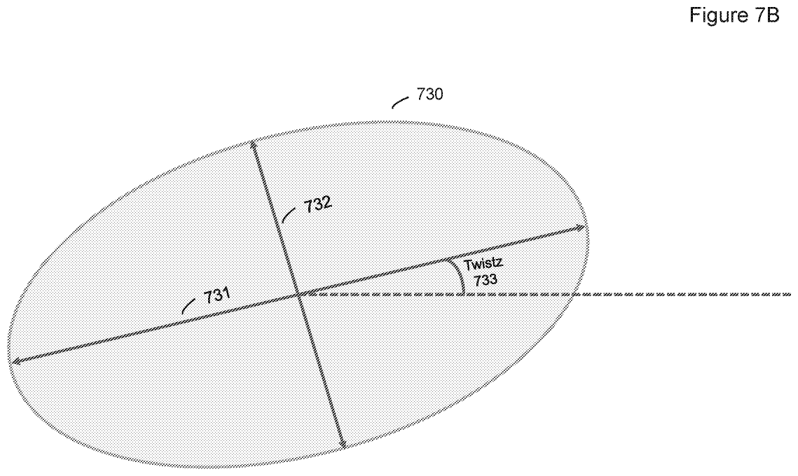

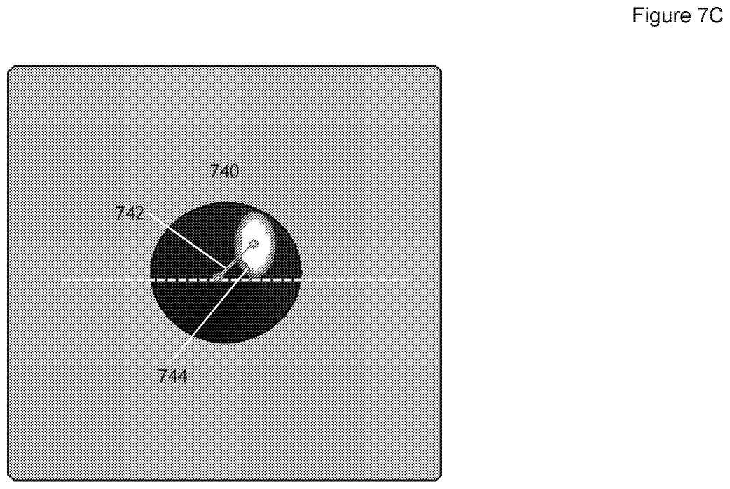

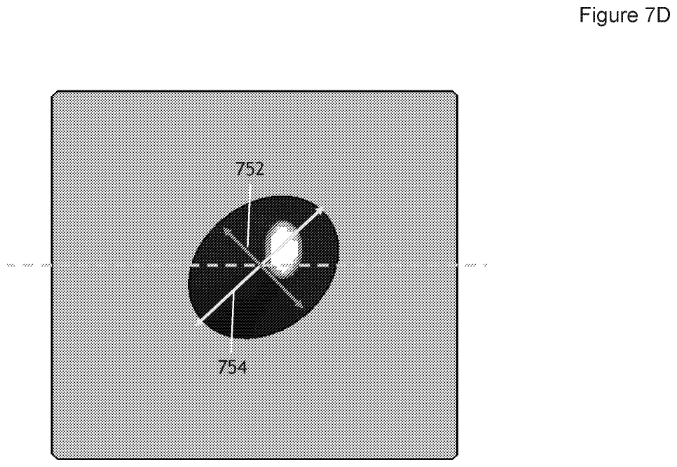

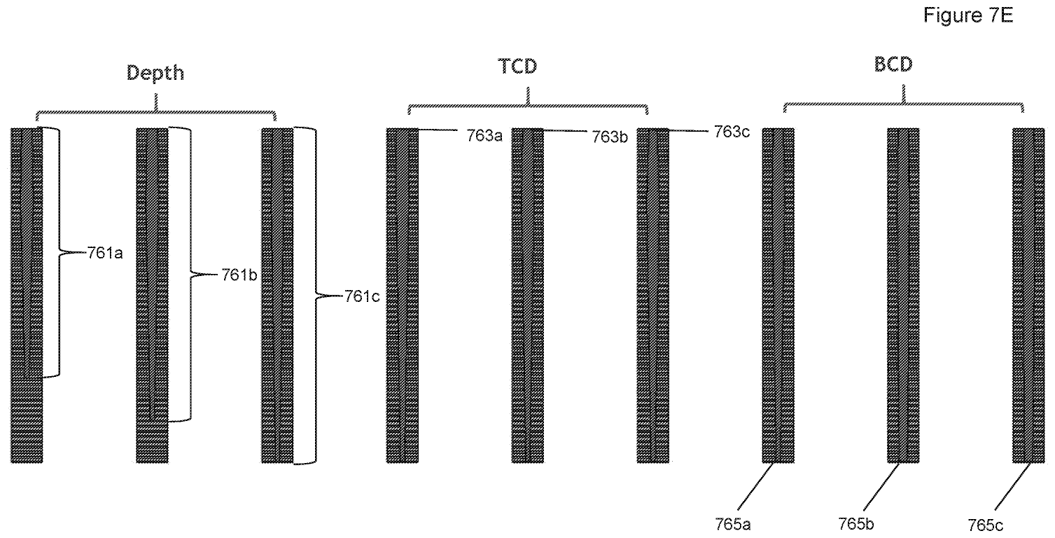

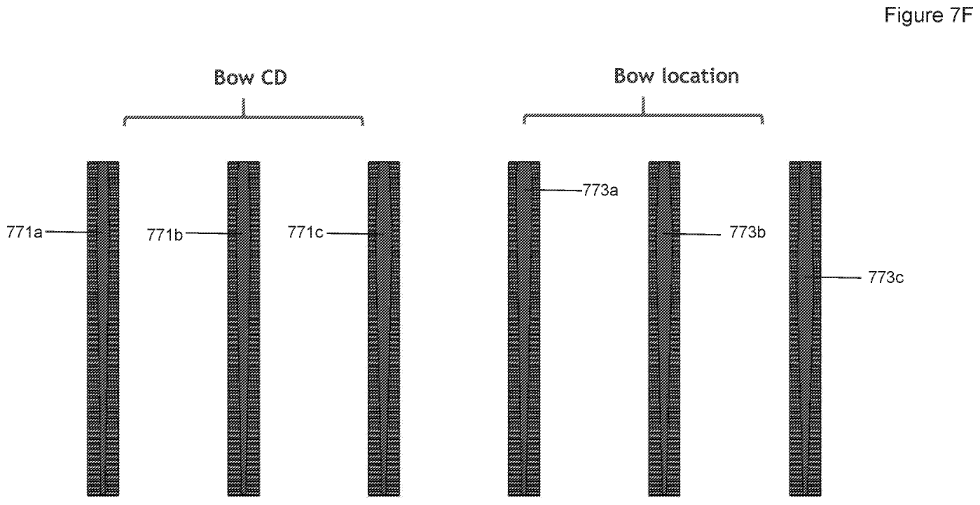

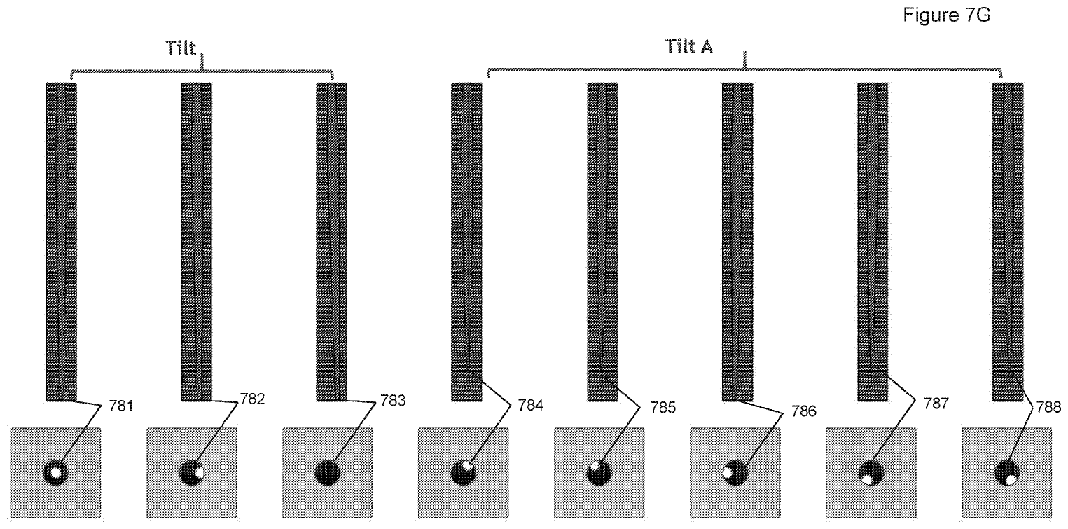

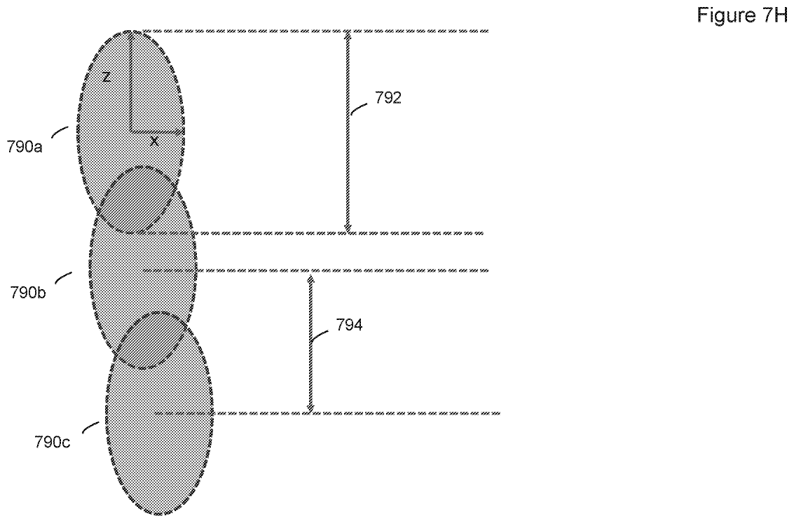

FIGS. 7A-7G graphically depict exemplary input parameters used for the hole profile modeling step in an embodiment. In FIG. 7A, on the right side of the figure, the locations of the top cd 702, the bow cd 704 and the bottom cd 706 are illustrated in the channel hole 700. Also depicted are the bow elevation 708 representing the distance between the bottom of the channel and the maximum bow location, and the depth 710 of the channel 700. Further depicted is the tilt 712 representing the lateral distance between the midpoint of the channel at the topcd location to the midpoint of the channel at the bottom cd location.

In FIG. 7A, on the left side of the figure, a series of “air” elliptical balls 721-727 are shown placed at various heights z in the channel 700. As discussed above, the first ball is placed at the startz location and then the movement, dimensions and orientation of the ellipsoid ball is controlled by the smooth, speed and other input parameters. During movement of the air elliptical ball in the hole profile modeling step, materials listed as adjacent to the channel in the 3D structural model that come into contact with the ball during its traversal are replaced by air in the model data so that the shape of the channel hole is modified by the ball's passage.

In FIG. 7B, an exemplary channel hole 730 at a designated height z in the channel is shown. In one embodiment, the critical dimension of the channel 730 at the height z may be specified in terms of the long axis (x) of the channel 731, the short axis (y) 732 and the ratio between the two, short axis divided by long axis. For example, in user interface 600 the user may supply the long axis (tcdx) and ratio (tcdr). It will be appreciated that the ratio controls the circularity of the channel, with 1.0 indicating a circular channel and smaller ratio values indicating a more oval shape. Also depicted is the twist angle (twistz) 733 indicating the amount of rotation of the channel hole (counter-clockwise) at the current location z that has occurred as measured by the long axis position compared to the X axis).

FIG. 7C depicts the effect of a change in both the tilt and twist parameters. As shown, tilt is the distance that the center of the channel 740 at the depicted location z is offset a distance 742 from the center of the hole at the bottom and has further “twisted” 744 (changed angle) from the original long axis position at the top of the hole.

FIG. 7D depicts the effect in a change in circularity of the channel. The ratio (cdr) of the short axis y (cdy) 752 to long axis x (cdx) 754 controls the circularity (i.e.: cdr=cdy/cdx or alternatively cdy=cdx*cdr) with a cdr of 1 indicating a circle and the channel becoming increasingly more oval in shape as the cdr decreases in value.

FIG. 7E depicts differences in etch depth, tcd and bcd parameters. More particularly, progressively deeper etch depths 761a, 761b and 761c are shown. The top critical dimension may also vary. Tcds 763a, 763b and 763c show progressively larger to smaller tcds. Similarly, the bottom cds may also vary and beds 765a, 765b and 765c show progressively smaller to larger bottom critical dimensions.

The bowing feature in a channel or hole can occur in different places and have different dimensions. FIG. 7F depicts different bowing locations and different bow critical dimensions. More particularly, bowing cds 771a, 771b and 771c depict progressively narrower to wider bows. Similarly, bow locations 773a, 773b and 773c depict bows that occur respectively from the top towards the middle of the channel.

FIG. 7G depicts the effect of varying the tilt and twist parameters. Tilt 781 shows the bottom of the channel perfectly aligned with the top. Tilt 782 shows the bottom of the channel offset a bit but still visible while tilt 783 shows the bottom of the channel offset to the point it is not visible from the top of the channel. Twist parameters 784-788 show the change in angle of the hole as the hole rotates to varying degrees.

FIG. 7H depicts the movement of the air ellipsoid ball in response to the smooth and speed parameters in an embodiment. As noted, the smooth parameter controls the vertical height 792 of the air ellipsoid balls 790a, 790b, 790c. The speed parameter indicates the distance 794 between each ball. For example, in one embodiment as shown, the speed parameter indicates the distance between midpoints of each successive air ellipsoid ball 790a, 790b, 790c. By controlling the speed and smooth parameters, a user can control the amount of changes that take place in the hole profile. For example, smaller vertical heights and shorter distances will cause more iterations and changes to the air ellipsoid ball and thus take longer to perform than larger vertical heights and larger distances which will lead to fewer iterations during the hole sweep. Accordingly it should be appreciated that embodiments provide a particularly tunable approach to creating a hole profile via the sweep method described herein.

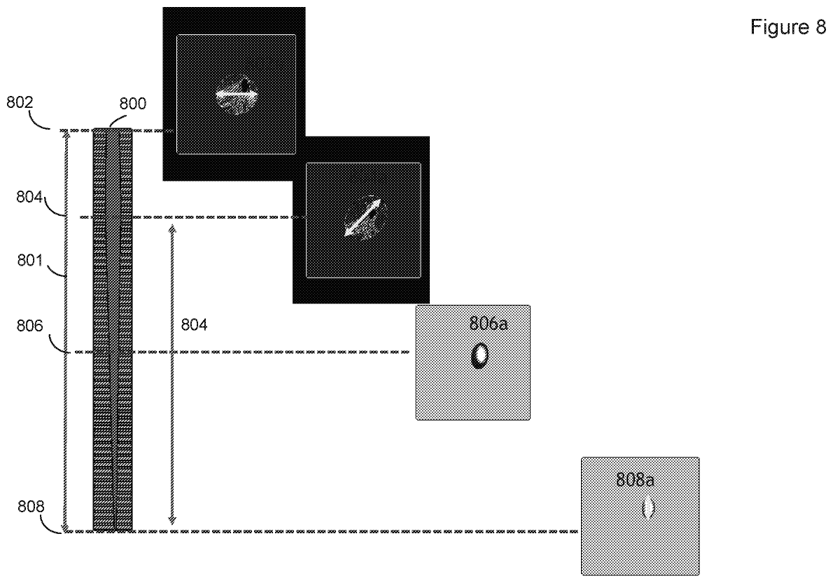

FIG. 8 depicts an exemplary hole profile in an embodiment. More particularly, a hole 800 with a depth 801 is shown. Also depicted is a starting z location (startz) 802 to begin the hole profile sweep, a bow cd location z 804 (the location of maximum bowing), an intermediate hole location 806, and a bottom hole location 808. Additionally shown are depictions of the hole at those locations (i.e. 802a, 804a, 806a and 808a) showing the change in size, shape and twist of the hole at the different locations. For example, it can be seen that the shape of the hole changes from a circle at the startz location 802 to an extremely narrow oval at the bottom location. Similarly, the twist can be seen to change from zero at the top to 45 degrees at the maximum bow location 804 to 90 degrees at the bottom hole location 808.

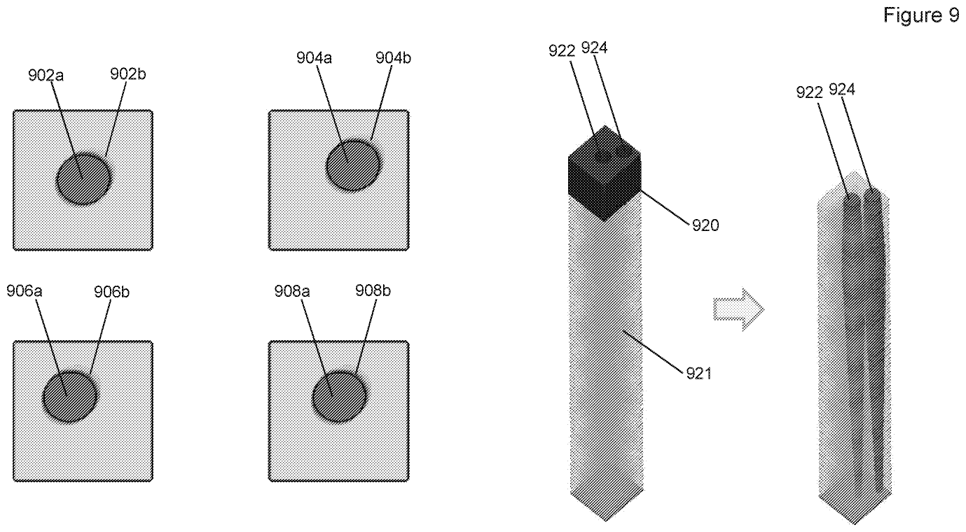

Embodiments enable holes from an incoming photoresist pattern to be overlayed and automatically aligned with existing holes in a structure being fabricated and the identification and individual profiling of multiple holes in the structure at their correct locations. FIG. 9 depicts an incoming photoresist pattern overlay split in which the holes from the incoming pattern 902a, 904a, 906a and 908a are automatically aligned with existing holes 902b, 904b, 906b and 908b. FIG. 9 also depicts photoresist 920 applied to structure 921 with two holes 922 and 924 and the eventual hole profiles.

Embodiments enables users to tune parameters to achieve results tailored to the problem at hand. For example users may adjust the resolution, smooth and speed parameters to achieve results in a desired time frame. The chart below provides an example of the differing time periods that may be achieved by adjusting the resolution, smooth and speed parameters in an exemplary embodiment. For example, it will be noted from the results that increasing or decreasing the resolution and speed parameters appear to have had the biggest effect on the duration of fabrication runs while adjustments to the smoothing parameter had a lesser effect. The results may also be examined in order to determine whether it is necessary to tune parameters for other reasons. As a non-limiting example, the area column holds values for the visible area results in the DOE. This visible area is the overlapped area of the top and bottom holes which can be detected from a top view and is a measurement taken after the structure is built. The area value results should be close to each other if the generated hole is smooth enough. For example, in the chart below, the Run 6 area value is abnormal become the “smooth” value is too small in comparison to the other runs indicating that the generated structure is much rougher/too rough. As a result, a user viewing these results may wish to set the “smooth” value to properly to trade off with simulation speed and structure accuracy. It should be appreciated that in some alternate embodiments the virtual fabrication environment may control the adjustment of parameters programmatically rather than the user indicating changes.

| Run | Resolution | Smooth | Speed | Area | Duration |
|---|---|---|---|---|---|
| Run-0 | 5 | 4 | 5 | 1261.621094 | 0:01:12 |
| | | | | | (H:M:S) |
| Run-1 | 3 | 4 | 5 | 1331.859375 | 0:02:02 |
| | | | | | (H:M:S) |
| Run-2 | 2 | 4 | 5 | 1300.734375 | 0:02:29 |
| | | | | | (H:M:S) |
| Run-3 | 1 | 4 | 5 | 1161.621094 | 0:04:28 |
| | | | | | (H:M:S) |
| Run-4 | 2 | 6 | 5 | 1329.59375 | 0:02:37 |
| | | | | | (H:M:S) |
| Run-5 | 2 | 2 | 5 | 1061.375 | 0:02:24 |
| | | | | | (H:M:S) |
| Run-6 | 2 | 1 | 5 | 159.65625 | 0:02:22 |
| | | | | | (H:M:S) |
| Run-7 | 2 | 4 | 8 | 1239.796875 | 0:02:07 |
| | | | | | (H:M:S) |
| Run-8 | 2 | 4 | 3 | 1307.8125 | 0:03:01 |
| | | | | | (H:M:S) |
| Run-9 | 2 | 4 | 1 | 1309.578125 | 0:05:14 |
| | | | | | (H:M:S) |

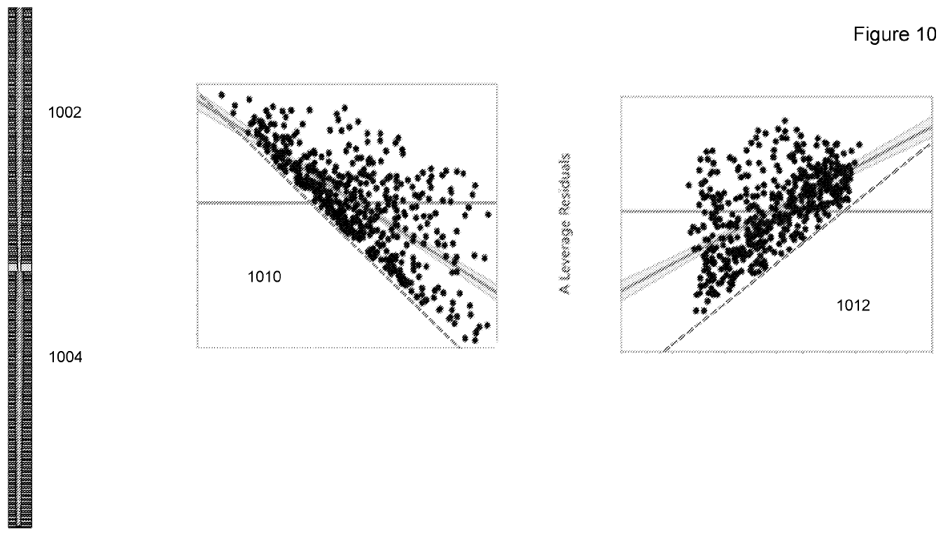

The ability generate a complicated hole profile by embodiments supports the performance of DOEs in the virtual fabrication environment. These DOEs may be performed to capture the process variation that occurs in the physical fab so as to enhance the design process. For example, a DOE may be performed for the two stack channel hole (128P) depicted in FIG. 10 in an exemplary embodiment to analyze the results of varying the tilt and twist in the holes 1002, 1004 formed from the upper and lower stacks. More particularly, in an embodiment, the user may choose to execute a 500 run Monte Carlo simulation with assigned values for the resolution, speed and smooth parameters and with minimum and maximum values for the input tilt and twist parameters between 0 and 360 degrees for the twist (“TiltA” in figure) parameter and 0 and 30 nm for the tilt parameter. The results may then be analyzed to indicate for example in a first result 1010 that if the lower tilt is unavoidable, letting the upper tilt grow larger than the lower tilt will result in a larger visible area. This larger visible area is due to the tilt and twist of the upper and lower hole. In a downstream etch process, this visible area will be a critical parameter to decide how much plasma can push through the hole and touch the bottom surface (In other words, lower tilt distance control is more important than upper tilt distance control), Also, based on the metrology distribution of the bottom tier, virtual fabrication can help determine the corresponding specifications of the top tier to help produce a two-tier structure with a larger visible area. It should be appreciated that the results may be displayed to users in another form such as, but not limited to a heat map.

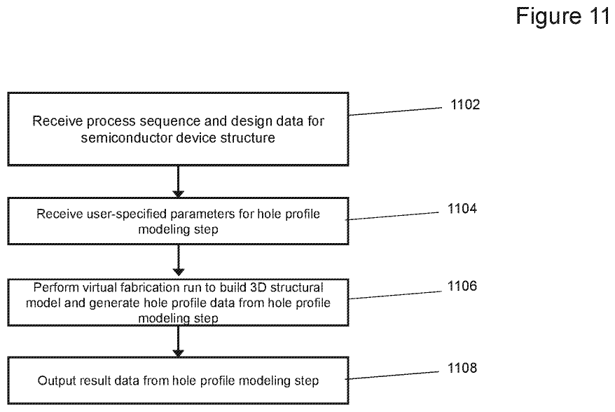

FIG. 11 depicts a sequence of steps performed in the virtual fabrication environment to perform hole profile modeling in an exemplary embodiment. The sequence begins with the receipt of a selection of a process sequence and design data (step 1102). User-specified parameters for a hole profile modeling step are then received (step 1104). The virtual fabrication environment then performs a virtual fabrication run to build a 3D structural model and generate hole profile data from the hole profile modeling step (step 1106). The result data from the hole profile modeling step may be output for display or further analysis (step 1108).

Although the description herein has described the use of voxel-based models simulated by the virtual fabrication environment, it should be appreciated that embodiments of the present invention are not so limited. In some embodiments, the techniques described herein for hole profile modeling may be applied in virtual fabrication environments that do not rely on voxel-based representation of models.

Portions or all of the embodiments of the present invention may be provided as one or more computer-readable programs or code embodied on or in one or more non-transitory mediums. The mediums may be, but are not limited to a hard disk, a compact disc, a digital versatile disc, a flash memory, a PROM, a RAM, a ROM, or a magnetic tape. In general, the computer-readable programs or code may be implemented in any computing language.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

The foregoing description of example embodiments of the invention provides illustration and description, but is not intended to be exhaustive or to limit the invention to the precise form disclosed. Modifications and variations are possible in light of the above teachings or may be acquired from practice of the invention. For example, while a series of acts has been described, the order of the acts may be modified in other implementations consistent with the principles of the invention. Further, non-dependent acts may be performed in parallel.

1. A non-transitory medium holding computer-executable instructions for performing hole profile modeling in a virtual fabrication environment, the instructions when executed causing at least one computing device to:
receive a process sequence and design data for a semiconductor device structure to be virtually fabricated;
receive a user-specified hole profile modeling step for the process sequence;
perform a virtual fabrication run using the process sequence and design data that builds a 3D structural model predictive of a result of a physical fabrication of the semiconductor device structure, execution of the hole profile modeling step generating a hole profile for one or more holes in the 3D structural model; and
output result data generated from the hole profile modeling step.

2. The medium of claim 1, wherein the instructions when executed further cause the at least one computing device to:
perform a plurality of virtual fabrication runs for the semiconductor device structure based on a Design of Experiment (DOE), the plurality of virtual fabrication runs building a plurality of 3D structural models predictive of a result of a physical fabrication of the semiconductor device structure, the hole profile modeling step modeling holes in the plurality of 3D structural models.

3. The medium of claim 1 wherein the instructions when executed cause the at least one computing device to:
provide a user interface in the virtual fabrication environment to receive user-specified parameters for the hole profile modeling step.

4. The medium of claim 3 wherein the parameters include one or more of a top cd (critical dimension), a bottom cd, a top cd ratio or a bottom cd ratio for the one or more holes.

5. The medium of claim 3 wherein the parameters include a bow cd location in the one or more holes.

6. The medium of claim 5 wherein the parameters include one or more of a maximum bow cd, a maximum bow cd ratio or a twist angle at the bow cd location.

7. The medium of claim 3 wherein the parameters include one or more of a twist angle at the top of the one or more holes and a twist angle at the bottom of the one or more holes.

8. The medium of claim 3 wherein the user-specified parameter is a circularity parameter representing the shape of the one or more holes.

9. The medium of claim 3 wherein the user-specified parameter is an etch depth parameter.

10. The medium of claim 3 wherein the user-specified parameter is one or more of a speed or smoothing parameter.

11. The medium of claim 1 wherein the result data is displayed in a 3D graphical view of the 3D structural model.

12. The medium of claim 1 wherein the one or more holes are a channel or via in the 3D structural model.

13. A computing device-implemented method for performing hole profile modeling in a virtual fabrication environment, comprising:
receiving a process sequence and design data for a semiconductor device structure to be virtually fabricated;
receiving a user-specified hole profile modeling step for the process sequence;
performing a virtual fabrication run using the process sequence and design data that builds a 3D structural model predictive of a result of a physical fabrication of the semiconductor device structure, execution of the hole profile modeling step generating a hole profile for one or more holes in the 3D structural model; and
outputting result data generated from the hole profile modeling step.

14. The method of claim 13, further comprising:
performing a plurality of virtual fabrication runs for the semiconductor device structure based on a Design of Experiment (DOE), the plurality of virtual fabrication runs building a plurality of 3D structural models predictive of a result of a physical fabrication of the semiconductor device structure, the hole profile modeling step modeling holes in the plurality of 3D structural models.

15. The method of claim 13, further comprising:
providing a user interface in the virtual fabrication environment to receive user-specified parameters for the hole profile modeling step.

16. The method of claim 15 wherein the parameters include one or more of a top cd (critical dimension), a bottom cd, a top cd ratio or a bottom cd ratio for the one or more holes.

17. The method of claim 15 wherein the parameters include a bow cd location in the one or more holes.

18. The method of claim 17 wherein the parameters include one or more of a maximum bow cd, a maximum bow cd ratio or a twist angle at the bow cd location.

19. The method of claim 15 wherein the parameters include one or more of a twist angle at the top of the one or more holes and a twist angle at the bottom of the one or more holes.

20. The method of claim 15 wherein the user-specified parameter is a circularity parameter representing the shape of the one or more holes.

21. The method of claim 15 wherein the user-specified parameter is an etch depth parameter.

22. The method of claim 15 wherein the user-specified parameter is one or more of a speed or smoothing parameter.

23. The method of claim 13, further comprising:
displaying the result data in a 3D graphical view of the 3D structural model.

24. The method of claim 13 wherein the one or more holes are a channel or via in the 3D structural model.

25. A system for performing hole profile modeling in a virtual fabrication environment, comprising:
at least one computing device equipped with one or more processors and configured to generate a virtual fabrication environment that includes a hole profile modeling module, the hole profile modeling module when executing:
receiving a process sequence and design data for a semiconductor device structure to be virtually fabricated;
receiving a user-specified hole profile modeling step for the process sequence;
performing a virtual fabrication run using the process sequence and design data that builds a 3D structural model predictive of a result of a physical fabrication of the semiconductor device structure, execution of the hole profile modeling step generating a hole profile for one or more holes in the 3D structural model; and
a display in communication with the at least one computing device, the display configured to display result data from the hole profile modeling step.
